(19) United States
(12) Patent Application Publication
(10) Pub. No.: US 2018/0168270 A1
(43) Pub. Date: Jun. 21, 2018

(54) Rail Connector For Earcup Suspension Assembly

(71) Applicant: Safariland, LLC, Jacksonville, FL (US)

(72) Inventor: Dylan Vaccaro, Jacksonville, FL (US)

(21) Appl. No.: 15/846,604

(22) Filed: Dec. 19, 2017

Related U.S. Application Data
(60) Provisional application No. 62/437,431, filed on Dec. 21, 2016.

(51) Int. Cl. A42B 3/30; H04R 1/02; H04R 1/10

(52) U.S. Cl. CPC A42B 3/30; H04R 1/105; H04R 1/1008; H04R 1/028

(57) ABSTRACT

An earcup suspension assembly is configured for connection with a rail on a helmet and for supporting an earcup over the user's ear. The assembly includes a rail connector configured for connection to the rail thereby to support the earcup suspension assembly on the rail, and an earcup suspension arm extending from the rail connector. The rail connector has a locked condition blocking rotation of the earcup suspension arm relative to the rail and an unlocked condition enabling rotation of the earcup suspension arm relative to the rail. The rail connector moves from the locked condition to the unlocked condition in response to movement of the earcup in a direction away from the user's ear.

### BACKGROUND OF THE INVENTION

A soldier or a fire fighter or a law enforcement officer often wears a headset to enable communication with colleagues. The headset typically includes two earcups and is sometimes worn with a protective helmet. Often the helmet has a rail mounted on the helmet, to support accessories. Known headsets have the earcups supported on the rail, and thereby on the helmet, by an earcup suspension assembly that is mounted on the rail. This application relates to a rail connector for connecting an earcup suspension assembly to a rail.

### SUMMARY OF THE INVENTION

In one embodiment, the invention is an earcup suspension assembly that is configured for connection with a rail on a helmet and for supporting an earcup over the user's ear. The assembly includes a rail connector configured for connection to the rail thereby to support the earcup suspension assembly on the rail, and an earcup suspension arm extending from the rail connector. The rail connector has a locked condition blocking rotation of the earcup suspension arm relative to the rail and an unlocked condition enabling rotation of the earcup suspension arm relative to the rail. The rail connector moves from the locked condition to the unlocked condition in response to movement of the earcup in a direction away from the user's ear.

### BRIEF DESCRIPTION OF THE DRAWINGS

FIG. 1 is a pictorial illustration of an earcup suspension assembly including a rail connector that is a first embodiment of the invention, shown supporting a left earcup on a rail on a left side of a helmet;

FIG. 2 is a pictorial illustration of a base that forms part of the rail connector of FIG. 1;

FIG. 3 is a pictorial illustration of a center part that forms part of the rail connector of FIG. 1;

FIG. 4 shows the rail connector with the suspension assembly in an active position;

FIG 5 shows the rail connector with the suspension assembly in an inactive position;

FIG. 6 illustrates rotation of the parts of the rail connector when in the inactive position; and

FIG. 7 is a sectional view through the rail connector with the suspension assembly shown in solid lines in the inactive position and in dashed lines in the active position.

### DETAILED DESCRIPTION

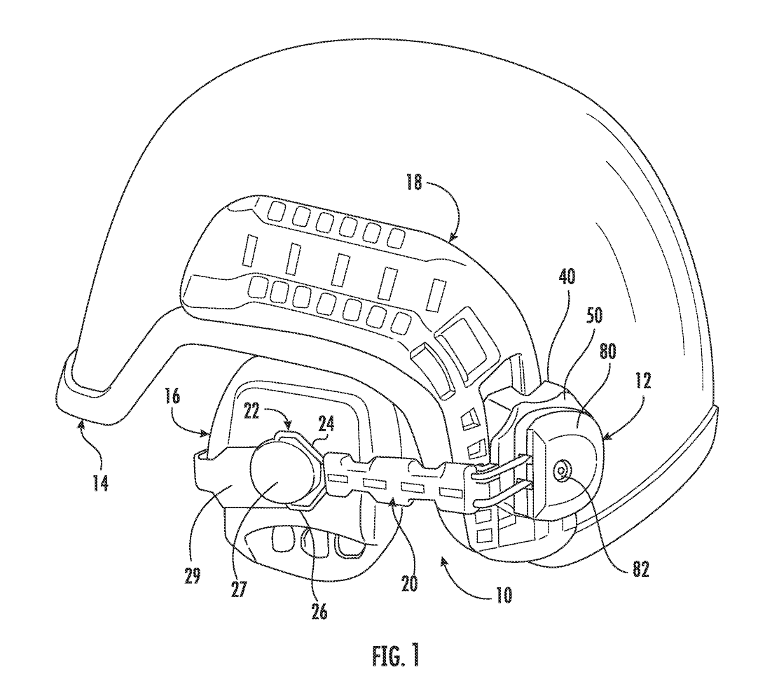

The present invention relates to a rail connector for an earcup suspension assembly. The invention is applicable to rail connectors of various types and configurations. As representative of the invention, FIG. 1 illustrates an earcup suspension assembly 10 including a rail connector 12 that is a first embodiment of the invention.

The earcup suspension assembly 10 is shown supported on a helmet 14. The term “helmet” as used herein is intended not to be limiting; specifically, the helmet 14 could be of any configuration, and could be a head covering device other than the type that is illustrated. The particular helmet 14 that is illustrated does not have portions covering the user's ears, thus allowing the earcup suspension assembly 10 to support an earcup 16 in a position covering the user's ear at a location outside of the enclosure of the helmet. The drawings show the helmet 14 as viewed from the left side; the right side is a mirror image, typically.

The helmet 14 is shown as supporting a rail 18. The term “rail” as used herein is intended not to be limiting; specifically, the rail 18 could be of any configuration, and is typically used to mean a device, often elongate, that is attached to a helmet such as the helmet 14 and that enables the releasable mounting of accessories on the helmet at selected positions along the length of the rail. The particular rail 18 that is illustrated is a standard ARC rail, but the invention is usable with other types of rails. Alternatively, an earcup suspension assembly 10 of the present invention can be supported on a different intermediate member that is not a “rail”, or can be supported directly on a helmet 14 or other final device. Thus, the term “rail” as used herein is intended to refer usually to that structure to which the earcup suspension assembly 10 is connected. The term “rail connector” can thus mean the portion of the earcup suspension assembly 10 that is fixedly supported on the helmet 14 or other final device, either directly or through an intermediate piece such as the rail 18.

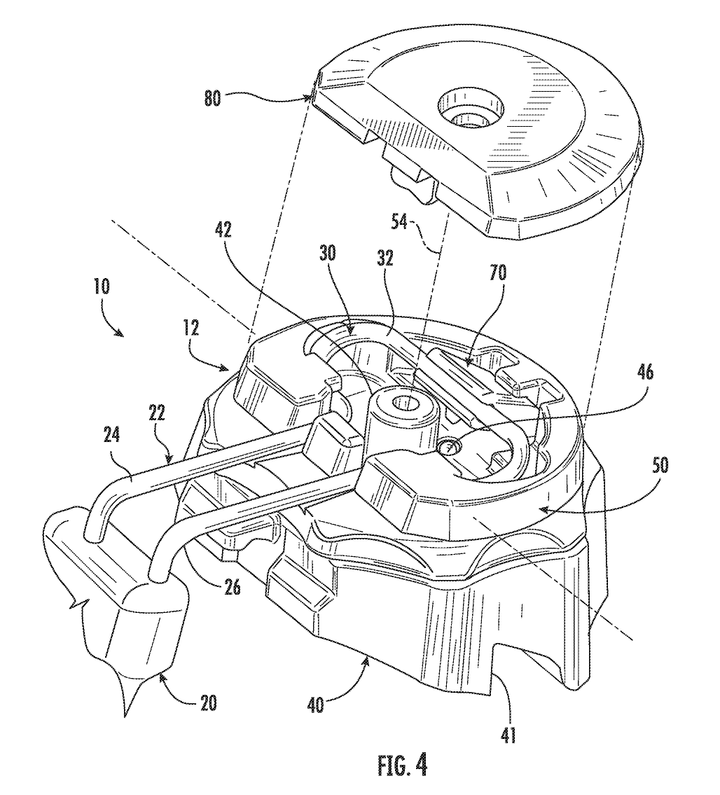

The earcup suspension assembly 10 includes an earcup suspension arm 20 (FIGS. 1 and 4) that extends from the rail connector. The particular earcup suspension arm 20 that is illustrated includes a wireform element 22, although a suspension arm as used herein need not be of the type that includes a wireform element. The wireform element 22 includes two wire legs 24 and 26 (FIG. 4) that extend the length of the wireform element. The legs 22 and 24 extend generally parallel to each other. The outer end portion 25 of the wireform element 22 (to the left as viewed in FIG. 1) is configured as two pins on the free ends of the legs 24 and 26, that extend laterally toward each other into a disc 27 that pivotally supports a bracket 29 secured to the earcup 16. As a result, the earcup 16 is supported on the suspension arm 20.

The inner (helmet) end portion of the wireform element 22 (FIG. 4) is formed as oval-shaped loop 30 that is wider than the spacing between the two legs 24 and 26. The loop 30 includes a loop end segment 32 that runs perpendicular to the overall length of the wireform element 22, at a point farthest from the outer end portion 27 of the wireform element.

The rail connector 12, in the illustrated embodiment, has four main parts: a base 40, a center part 50, a cam 70, and a cover 80.

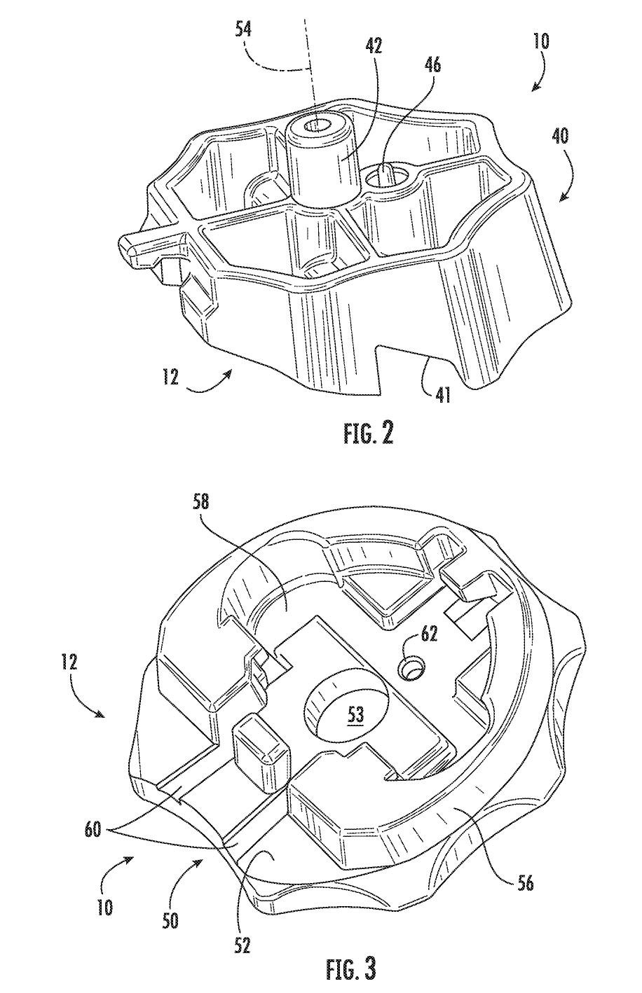

The base 40 (FIGS. 1 and 2) is the part of the rail connector 12 that is positioned on the rail 18, by a standard ARC rail connection feature shown only partially and schematically at 41. The feature 41 enables fixed but releasable positioning of the connector 12 at selected locations along the length of the rail 18. The base 40 is thus non-movable on the rail 18 when in a particular selected location on the rail.

The base 40 has a center post 42 that projects in a direction away from the rail. The base 40 also has a spring plunger assembly 44 that is located on the side of the center post 42 that is opposite to the suspension arm 20. The spring plunger assembly 44 includes a plunger 46 that is biased away from the rail 18 and toward the center part 50 (upward as viewed in FIG. 2), by a spring or other biasing member 48 (FIG. 7).

The center part 50 of the rail connector 12 (FIG. 3) is supported on the base 40. The center part 50 has a bottom wall 52 adjacent to and generally overlying the base 40. The bottom wall 52 has a central opening 53 through which the center post 42 of the base 40 projects. The center part 50 is thus supported on the base 40 for rotation relative to the base about a first axis 54 (FIG. 2).

The center part 50 (FIG. 3) of the rail connector 20 has a side wall 56 that projects outward (upward as viewed in FIG. 3) from the base bottom wall 52. The side wall 56 extends around the bottom wall 52, thereby forming, with the bottom wall, a wire end chamber 58 in the connector 12. The chamber 58 is shaped to receive the loop 30 that forms the inner end portion of the wireform element 22. Two wire channels 60 extend through the center part side wail 56 at a location circumferentially opposite the spring plunger 46. The bottom wall 52 of the center part 50 also has an opening 62 through which the spring plunger 46 projects into the chamber 58 when the center part is mounted on the base 40.

The cam 70 (FIGS. 4, 5, and 7) of the rail connector 12 is supported on the center part 50. The particular cam 70 that is illustrated has a plate-like configuration with one edge portion 72 (radially outward) engaged with the center part 50 and supporting the cam for pivoting movement relative to the center part 50. The opposite end 74 of the cam (to the left as viewed in FIGS. 4 and 5) is adapted to engage the end segment 32 of the loop 30 so as to be movable by the loop. In the illustrated embodiment, the end portion 74 of the cam 70 has a groove 76 that is suitable for receiving the end segment 32 of the loop 30. The bottom or underside of the cam is presented toward and is engageable by the spring plunger 46. A nub 78 on the underside of the cam 70 is positioned over the spring plunger 46.

The cover 80 is fastened to the base 40 by a fastener 82 extending into the center post 42. When the connector 12 is assembled with the wireform element 22 as shown in FIGS. 4 and 5, the wireform element 22 is captured between the cover 80 and the center part 50, Specifically, the two legs 24 and 26 of the wireform element 22 extend through the wire channels 60 in the side wall 56 of the center part 50. The loop end 30 of the wireform element 22 is located in the chamber 58 in the center part 50. The end segment 32 of the loop 30 is clipped into the open end of the cam 70. The cover 80 closes the chamber 58 and holds the loop end 30 in the chamber.

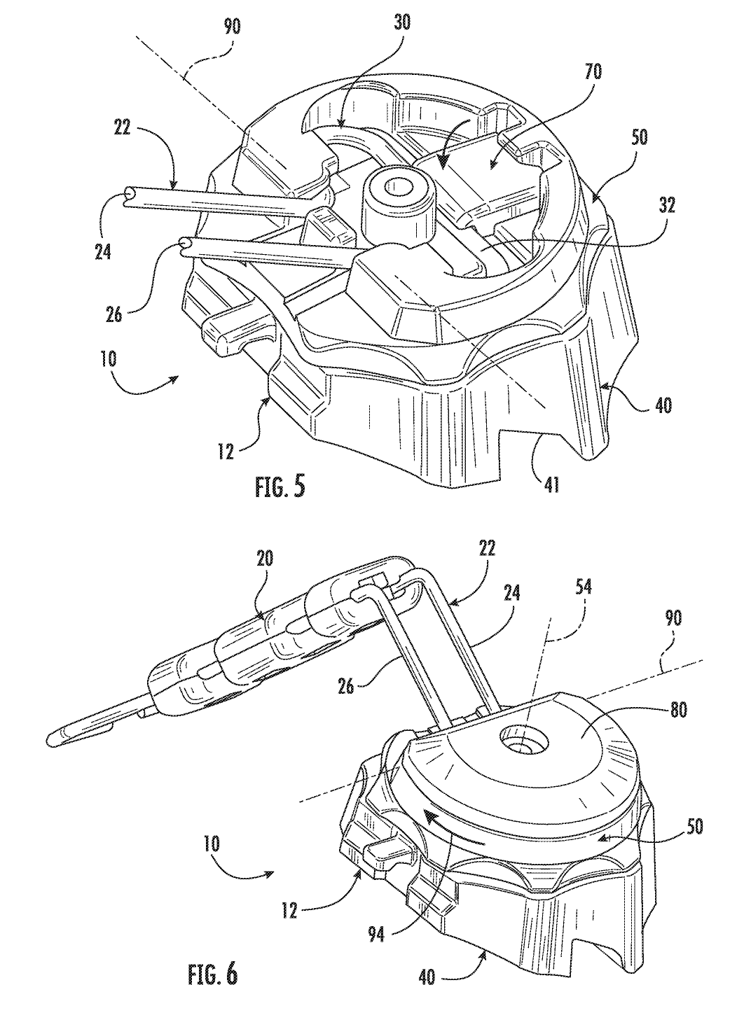

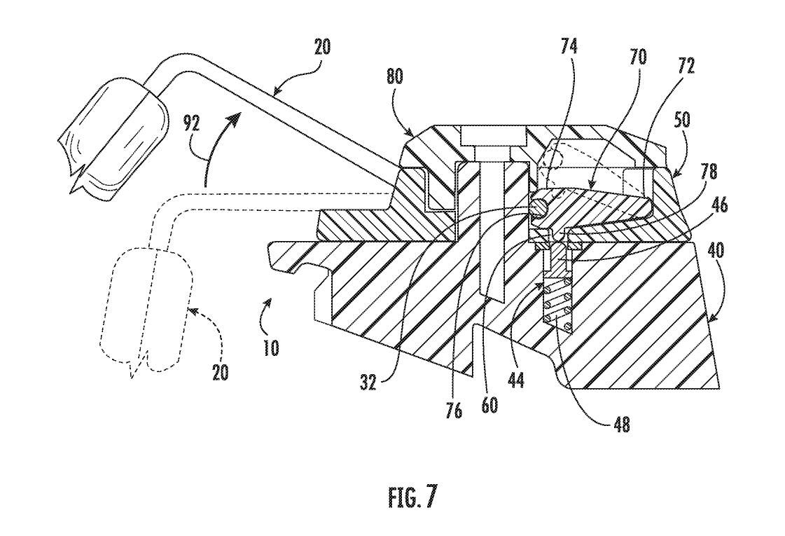

When the headset is in use, the earcup 16 and the suspension arm 20 are manually movable, relative to the rail 18, between an active position (FIGS. 1 and 4) in which the earcup typically covers the user's ear, and any one of a plurality of different inactive positions FIGS. 5 and 6) in which the earcup typically is spaced apart from the ear. The user manually flips or pivots the earcup 16 between the active position and the inactive position, about a second axis 90; as this occurs, the wireform element 22 and the suspension arm 20 as a whole pivot relative to the rail connector, as described below in detail.

Specifically, when the parts are in the active position (shown in FIGS. 1 and 4), the wireform element 22 of the suspension arm 20 is oriented, relative to the connector 12, so that the end segment 32 of the loop 30 is spaced apart from the spring plunger 46 and from the bottom wall 52 of the center part 50 (upward as viewed in FIG. 4). The loop end segment 32, by virtue of its engagement in the groove 76 of the cam 70, pulls the cam end portion 74 up in a direction away from the spring plunger 46. As a result, the spring plunger 46 is able to extend above the bottom wall 52 and into the opening 62 in the center part 50 of the connector 12. The spring plunger 46 thus forms a detent or blocking member that selectively blocks rotation of the center part 50 and the suspension arm 20 about the first axis 54, relative to the base 40 and the rail 18. Also, the wireform element legs 24 and 26 are located in the wire channels 60 of the center part 50.

The engagement of the spring plunger 46 in the opening 62 blocks rotational movement of the center part 50 relative to the spring plunger. This engagement thus blocks rotation of the center part 50, as a whole, on the base 40. Because the center part 50 of the connector 12 is blocked from rotation on the base 40, so also are the wireform element 22 and the earcup 16 blocked from rotation on the base 40. As a result, the earcup 16 is held in the active position covering the user's ear. The connector 12 thus “locks” the parts in this rotational position. This position is also shown in dashed lines in FIG. 7.

When the user pulls (pivots) the earcup 16 outward off (away from) the user's ear, the connection of the wireform element 22 with the earcup causes the wireform element to pivot relative to the connector 12, about a second axis 90 located at about the location of the channels 60, as indicated by the arrow 92 in FIG. 7. The second axis 90 extends transverse to the first axis 54. The end segment 32 of the wire loop 30, moves in a direction toward the spring plunger 46 and toward the bottom wall 52 of the center part 50. This movement of the end segment 32 of the wire loop 30, which is engaged in the groove 76 of the cam 70, causes the cam 70 to pivot toward the bottom wall 52 of the center part 50. The nub 72 on the cam 70 engages the projecting tip of the spring plunger 46 and pushes the spring plunger down against the bias of the spring, out of the opening 62 in the bottom wall 52 of the center part 50. As a result, the center part 50 of the connector 12 is free to rotate on the base 40 about the first axis 54, in a direction as indicated by the arrow 94 (FIG. 6). The user can then rotate the earcup 16 to another position relative to the helmet 14, for example, upward and/or backward.

The description above is of one embodiment of the invention. Additional embodiments are possible, as are variations in the physical parts shown and described.

1. An earcup suspension assembly configured for connection with a rail on a helmet and for supporting an earcup over an ear of a user wearing the helmet, the earcup suspension assembly comprising;
a rail connector configured for connection to the rail thereby to support the earcup suspension assembly on the rail; and
earcup suspension arm extending from the rail connector;
the rail connector having a locked condition blocking rotation of the earcup suspension arm relative to the rail and an unlocked condition enabling rotation of the earcup suspension arm relative to the rail;
the rail connector moving from the locked condition to the unlocked condition in response to movement of the earcup in a direction away from the user's ear.

2. An earcup suspension assembly as set forth in claim 1 wherein the suspension arm pivots relative to the rail connector when the rail connection moves from the locked condition to the unlocked condition.

3. An earcup suspension assembly as set forth in claim 2 wherein the earcup suspension arm depresses a spring plunger when the rail connection moves from the locked condition to the unlocked condition to enable rotation of the suspension arm relative to the rail.

4. An earcup suspension assembly as set forth in claim 1 wherein the earcup suspension arm is supported on the rail for rotational movement relative to the rail about a first axis and is pivotable relative to the rail connector about a second axis extending transverse to the first axis.

5. An earcup suspension assembly as set forth in claim 4 wherein the earcup suspension arm includes a wireform element that has two generally parallel legs extending into the rail connector at their one end and pivotally connected with the earcup at the their opposite end.

6. An earcup suspension assembly as set forth in claim 1 wherein the rail connector is configured for selective releasable positioning on an ARC rail.

7. An earcup suspension assembly configured for connection with a rail on a helmet and for supporting an earcup over an ear of a user wearing the helmet, the earcup suspension assembly comprising;
a rail connector configured for connection to the rail thereby to support the earcup suspension assembly on the rail;
the rail connector including a base releasably fixed on the rail and a center part that is supported on the base for rotational movement relative to the base about a first axis;
an earcup suspension arm extending from the rail connector and pivotable relative to the rail connector about a second axis extending transverse to the first axis;
the rail connector having a locked condition blocking rotation of the center part and the earcup suspension arm about the first axis relative to the base and the rail, and having an unlocked condition enabling rotation of the earcup suspension arm and the center part about the first axis relative to the base and the rail;
the rail connector moving from the locked condition to the unlocked condition in response to outward pivoting movement of the earcup about the second axis in a direction away from the user'ear, thereby enabling rotation of the earcup suspension arm and the center part about the first axis relative to the base and the rail.
